(19) United States
(12) Patent Application Publication
(10) Pub. No.: US 2026/0217216 A1
(43) Pub. Date: Jul. 30, 2026

(54) VEHICLE CONTROL DEVICE

(71) Applicant: TOYOTA JIDOSHA KABUSHIKI KAISHA, Toyota-shi (JP)

(72) Inventors: Hiroki TAKEISHI, Machida-shi (JP); Yuta TAKATA, Toyota-shi (JP); Mizuki MAJIMA, Ichinomiya-shi (JP); Ryota TATSUMI, Nagoya-shi (JP)

(73) Assignee: TOYOTA JIDOSHA KABUSHIKI KAISHA, Toyota-shi (JP)

(21) Appl. No.: 19/405,678

(22) Filed: Dec. 2, 2025

(30) Foreign Application Priority Data
Jan. 28, 2025 (JP) 2025-012446

(51) Int. Cl. B60R 25/04; B60R 25/10; B60R 25/32; B60R 25/33

(52) U.S. Cl. CPC B60R 25/04; B60R 25/10; B60R 25/32; B60R 25/33

(57) ABSTRACT

A vehicle control device includes a processor, which remotely controls a vehicle to lock engine start of the vehicle by outputting, to the vehicle, a signal for activating an immobilizer of the vehicle when the vehicle satisfies a predetermined requirement of engine start lock, and remotely controls the vehicle to release lock of the engine start by outputting, to the vehicle, a signal for releasing activation of the immobilizer of the vehicle when acquiring release application information of the engine start lock. Further, the release application information includes at least one of information on a use period of the vehicle and information on a destination of the vehicle.

### CROSS-REFERENCE TO RELATED APPLICATION(S)

The present application claims priority to and incorporates by reference the entire contents of Japanese Patent Application No. 2025-012446 filed in Japan on January 28, 2025.

### BACKGROUND

The present disclosure relates to a vehicle control device.

U.S. Patent Application Publication No. 2023/0055958 discloses a technique of temporarily releasing engine start lock in a case where a user makes a request of releasing the engine start lock in an emergency (e.g., hospital) after the engine start of the vehicle is locked.

### SUMMARY

There is a need for providing a vehicle control device capable of releasing engine start lock based on the contents of an application for release of the engine start lock.

According to an embodiment, a vehicle control device includes a processor, which remotely controls a vehicle to lock engine start of the vehicle by outputting, to the vehicle, a signal for activating an immobilizer of the vehicle when the vehicle satisfies a predetermined requirement of engine start lock, and remotely controls the vehicle to release lock of the engine start by outputting, to the vehicle, a signal for releasing activation of the immobilizer of the vehicle when acquiring release application information of the engine start lock. Further, the release application information includes at least one of information on a use period of the vehicle and information on a destination of the vehicle.

According to an embodiment, a vehicle control device includes a processor, which remotely controls a vehicle to lock engine start of the vehicle when the vehicle satisfies a predetermined requirement of engine start lock, and remotely controls the vehicle to release lock of the engine start when acquiring release application information of the engine start lock. Further, the release application information includes at least one of information on a use period of the vehicle and information on a destination of the vehicle.

### BRIEF DESCRIPTION OF THE DRAWINGS

FIG. 1 is a block diagram illustrating a schematic configuration of a vehicle control system including a vehicle control device according to an embodiment;

FIG. 2 is a flowchart illustrating an example of the flow of first processing in a debt collection server that functions as the vehicle control device according to the embodiment; and

FIG. 3 is a flowchart illustrating an example of the flow of second processing in the debt collection server that functions as the vehicle control device according to the embodiment.

### DETAILED DESCRIPTION

In the related art, a user is assumed to make a request of releasing engine start lock not only in an emergency but in various other situations. The technique of U.S. Patent Application Publication No. 2023/0055958 thus cannot deal flexibly with a situation other than an emergency, and has room for improvement.

A vehicle control device according to an embodiment of the present disclosure will be described with reference to the drawings. Note that components in the embodiment below include those that can be easily replaced by those skilled in the art or those that are substantially the same.

### Vehicle Control System

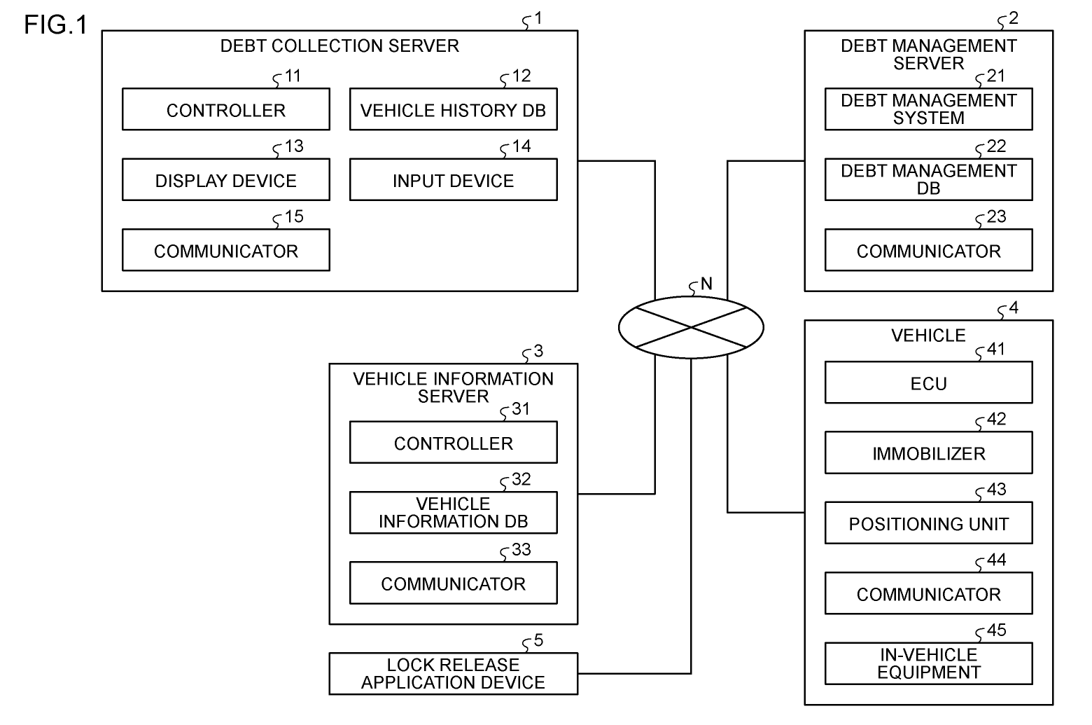

A vehicle control system according to the embodiment will be described with reference to FIG. 1. As illustrated in FIG. 1, the vehicle control system includes a debt collection server 1, a debt management server 2, a vehicle information server 3, a vehicle 4, and a lock release application device 5. In the vehicle control system according to the embodiment, the debt collection server 1 functions as a vehicle control device that controls an operation (e.g., engine start lock) of the vehicle 4.

All of the debt collection server 1, the debt management server 2, the vehicle information server 3, the vehicle 4, and the lock release application device 5 have communication functions, mutually communicate through a network N, and exchange various pieces of information with each other. The network N includes a public line network such as an internet network and a mobile phone network.

### Debt Collection Server

The debt collection server 1 remotely controls the vehicle 4 in order to collect a debt related to the vehicle 4. Examples of the "debt" of the embodiment include a debt related to an installment contract at the time when a vehicle is purchased, a debt related to a lease contract of the vehicle 4, a debt related to a subscription contract of the vehicle 4, a debt related to a rental-car contract of the vehicle 4, and a debt related to a car-sharing contract of the vehicle 4.

Furthermore, a creditor in the embodiment is, for example, a holder (owner) of the vehicle 4. Specific examples of the creditor include a dealer of the vehicle 4, a credit company, and a car-sharing company. Furthermore, a debtor in the embodiment is, for example, a user of the vehicle 4. Furthermore, specific examples of the debtor include a purchaser of the vehicle 4 and contractors of a lease contract, a rental-car contract, and a car-sharing contract.

As illustrated in FIG. 1, the debt collection server 1 includes a controller 11, a vehicle history DB 12, a display device 13, an input device 14, and a communicator 15.

The controller 11 includes a processor and a memory (main storage). The processor includes, for example, a central processing unit (CPU). The memory (main storage) includes a random access memory (RAM) and a read only memory (ROM).

When the vehicle 4 satisfies a predetermined requirement of the engine start lock (hereinafter, referred to as "engine start lock requirement"), the controller 11 remotely controls the vehicle 4 to lock engine start of the vehicle 4. In this case, the controller 11 outputs a signal for activating an immobilizer 42 to the vehicle 4 through the network N, and activates the immobilizer 42. The controller 11 thereby remotely locks the engine start of the vehicle 4. Note that the above-described signal for activating the immobilizer 42 is transmitted specifically from the controller 11 to the vehicle information server 3, and is transmitted to the vehicle 4 via the vehicle information server 3.

Examples of the "case where an engine start lock requirement is satisfied" include a case where the user of the vehicle 4 has been in default. Examples of the "default" include delay in paying back a loan for the vehicle 4 and paying a lease fee, a rental-car fee, and a sharing fee of the vehicle 4 and delay in returning the vehicle 4 after use.

For example, the debt management server 2 determines whether or not an engine start lock requirement is satisfied. That is, when the debt management server 2 determines that there is a vehicle 4 that satisfies the engine start lock requirement, information for identifying the vehicle 4 is transmitted from a debt management system 21 to the debt collection server 1. Examples of the information for identifying the vehicle 4 include a vehicle identification number (VIN number) and information on the position of the vehicle 4 (hereinafter, referred to as "vehicle position information").

Then, when acquiring information on the vehicle 4 that satisfies the engine start lock requirement from the debt management system 21, the controller 11 remotely controls the vehicle 4 to lock the engine start of the vehicle 4 via the vehicle information server 3 as described above.

Furthermore, when receiving an application for release of the engine start lock from the user of the vehicle 4 after the engine start lock of the vehicle 4, the controller 11 remotely controls the vehicle 4 to release the engine start lock only for a predetermined period. In this case, when acquiring release application information of engine start lock (hereinafter, referred to as "release application information") from the lock release application device 5, the controller 11 outputs, to the vehicle 4, a signal for releasing the activation of the immobilizer 42 via the network N to release the activation of the immobilizer 42. The controller 11 thereby remotely releases the engine start lock of the vehicle 4. Note that the above-described signal for releasing the activation of the immobilizer 42 is transmitted specifically from the controller 11 to the vehicle information server 3, and is transmitted to the vehicle 4 via the vehicle information server 3.

Furthermore, after the elapse of a predetermined period from the release of the engine start lock as described above, the controller 11 remotely controls the vehicle 4 to lock the engine start again.

Furthermore, if the vehicle 4 travels off a route, for which an application has been made, during the release of the engine start lock, the controller 11 may warn the user of the vehicle 4. In this case, after the release of the engine start lock, the controller 11 acquires information on the position of the vehicle 4 (vehicle position information) and information on the speed of the vehicle 4 (vehicle speed information) through the vehicle information server 3 at each predetermined timing. That is, the controller 11 monitors the position and speed of the vehicle 4 after the release of the engine start lock.

Then, when detecting that the vehicle 4 is traveling off a route to a destination (goal) included in the release application information during the release of the engine start lock, the controller 11 remotely controls the vehicle 4 to cause in-vehicle equipment 45 of the vehicle 4 to output predetermined warning information. In this case, the controller 11 generates the predetermined warning information, and transmits the warning information to the vehicle information server 3. In response, the vehicle information server 3 transfers the warning information to the vehicle 4 to cause the in-vehicle equipment 45 of the vehicle 4 to output the warning information.

Examples of the in-vehicle equipment 45 include a display of a car navigation system and a car audio system.

Furthermore, examples of the "warning information" include character information and voice information warning that the vehicle 4 is off the route to the destination included in the release application information.

Furthermore, if the vehicle 4 is parked at a place off the route to the destination included in the release application information during the release of the engine start lock, the controller 11 remotely controls the vehicle to lock the engine start of the vehicle 4. In this case, the controller 11 determines whether or not the vehicle 4 has a speed of 0 (speed of 0 for certain time) at the place off the route to the destination included in the release application information. Then, when determining that the vehicle has a speed of 0, the controller 11 remotely controls the vehicle 4 to lock engine start of the vehicle 4.

As described above, the debt collection server 1 can inhibit unintended use of the vehicle 4 of the user by appropriately warning the user through the in-vehicle equipment 45 not to travel off the route for which an application has been made after the release of the engine start lock.

Furthermore, when the vehicle 4 is about to be parked at a place other than the destination (goal) for which an application has been made during the release of the engine start lock, the controller 11 may warn the user of the vehicle 4. In this case, after the release of the engine start lock, the controller 11 acquires information on the position of the vehicle 4 (vehicle position information) and information on the speed of the vehicle 4 (vehicle speed information) through the vehicle information server 3 at each predetermined timing. That is, the controller 11 monitors the position and speed of the vehicle 4 after the release of the engine start lock.

Then, when the vehicle 4 decelerates to a predetermined speed at a place other than the destination (goal) included in the release application information during the release of the engine start lock, the controller 11 remotely controls the vehicle 4 to cause the in-vehicle equipment 45 of the vehicle 4 to output predetermined warning information. In this case, the controller 11 generates the predetermined warning information, and transmits the warning information to the vehicle information server 3. In response, the vehicle information server 3 transfers the warning information to the vehicle 4 to cause the in-vehicle equipment 45 of the vehicle 4 to output the warning information.

Examples of the in-vehicle equipment 45 include a display of a car navigation system and a car audio system. Furthermore, examples of the "warning information" include character information and voice information giving a warning against parking at a place other than the destination included in the release application information. Furthermore, examples of "decelerates to a predetermined speed" include a state of continuous deceleration to a speed lower than that of a crawl.

Furthermore, if the vehicle 4 is parked at a place other than the destination included in the release application information during the release of the engine start lock, the controller 11 remotely controls the vehicle to lock the engine start of the vehicle 4. In this case, the controller 11 determines whether or not the vehicle 4 has a speed of 0 (speed of 0 for certain time) at the place other than the destination included in the release application information. Then, when determining that the vehicle has a speed of 0, the controller 11 remotely controls the vehicle 4 to lock engine start of the vehicle 4.

As described above, the debt collection server 1 can inhibit unintended use of the vehicle 4 of the user by appropriately warning the user through the in-vehicle equipment 45 not to park the vehicle 4 at a place other than the destination for which an application has been made after the release of the engine start lock.

Furthermore, when the engine start lock is released as described above and a time zone when the user can use the vehicle 4 (lock release time zone) elapses, the controller 11 remotely controls the vehicle 4 to lock the engine start again. Furthermore, when the engine start lock is released as described above and a period when the user can use the vehicle 4 (lock release period) elapses, the controller 11 remotely controls the vehicle 4 to lock the engine start again. For example, the release application information transmitted from the lock release application device 5 to the debt collection server 1 includes the lock release time zone and the lock release period described above. The remaining configuration of the debt collection server 1 will be described below.

The vehicle history DB 12 is a database that accumulates various pieces of information on the vehicle 4. For example, the vehicle history DB 12 accumulates information as follows.

(1) Vehicle Identification Number (VIN number) of Vehicle 4

(2) Vehicle Position Information of Vehicle 4

(3) Speed of Vehicle 4 (Vehicle Speed)

For example, a liquid crystal display (LCD) and an organic EL display (OLED) implement the display device 13. The display device 13 displays various pieces of information created by the controller 11. Furthermore, for example, a keyboard and a pointing device implement the input device 14. The input device 14 inputs various pieces of information to the controller 11.

The communicator 15 includes, for example, a local area network (LAN) interface board and a wireless communication circuit for wireless communication. The communicator 15 exchanges information with the debt management server 2 and the vehicle information server 3 by communication via the network N.

### Debt Management Server

The debt management server 2 manages a debt related to the vehicle 4. As illustrated in FIG. 1, the debt management server 2 includes the debt management system 21, a debt management DB 22, and a communicator 23.

When there is a vehicle 4 that satisfies the engine start lock requirement among vehicles 4 managed in the debt management DB 22, the debt management system 21 transmits information for identifying the vehicle 4 (e.g., vehicle identification number (VIN number)) to the debt collection server 1.

The debt management DB 22 is a database that accumulates, for example, information for identifying the vehicle 4 (e.g., vehicle identification number (VIN number)) and information on a debt (e.g., loan debt and lease debt) of the vehicle 4.

The communicator 23 includes, for example, a LAN interface board and a wireless communication circuit for wireless communication. The communicator 23 exchanges information with the debt collection server 1 by communication via the network N.

### Vehicle Information Server

The vehicle information server 3 includes a controller 31, a vehicle information DB 32, and a communicator 33.

For example, a processor including a CPU and a memory (main storage) including a RAM and a ROM implement the controller 31. When acquiring a signal for activating the immobilizer 42 of the vehicle 4 from the debt collection server 1, the controller 31 remotely locks the engine start of the vehicle 4 by transferring the signal to the vehicle 4. Furthermore, when acquiring a signal for releasing the activation of the immobilizer 42 of the vehicle 4 from the debt collection server 1, the controller 31 remotely releases the engine start lock of the vehicle 4 by transferring the signal to the vehicle 4.

Furthermore, when acquiring warning information from the debt collection server 1, the controller 31 remotely controls the vehicle 4 to cause the in-vehicle equipment 45 of the vehicle 4 to output predetermined warning information by transferring the warning information to the vehicle 4.

The vehicle information DB 32 is a database that accumulates various pieces of information acquired from the vehicle 4. For example, the vehicle information DB 32 accumulates information (vehicle information) as follows. Furthermore, the vehicle information DB 32 transmits the following information to the debt collection server 1 in accordance with a request from the debt collection server 1.

(1) Vehicle Identification Number (VIN number) of Vehicle 4

(2) Vehicle Position Information of Vehicle 4

(3) Travel Course (Travel Route) of Vehicle 4

(4) Speed of Vehicle 4 for Each Travel Course

(5) Warning Information Acquired from Debt Collection Server 1

The communicator 33 includes, for example, a LAN interface board and a wireless communication circuit for wireless communication. The communicator 33 exchanges information with the debt collection server 1 and the vehicle 4 by communication via the network N.

### Vehicle

Examples of the vehicle 4 include a common engine vehicle (related-art vehicle), a hybrid electric vehicle (HEV), and a plug-in hybrid electric vehicle (PHEV). Furthermore, examples of the vehicle 4 may include a fuel cell electric vehicle (FCEV) and a battery electric vehicle (BEV). The vehicle 4 includes an ECU 41, the immobilizer 42, a positioning unit 43, and a communicator 44.

The ECU 41 is an electronic control unit including a microcomputer such as a CPU, a ROM, and a RAM as a main component. The ECU 41 transmits information including at least vehicle position information to the vehicle information server 3 in accordance with a request from the vehicle information server 3.

When acquiring a signal for activating the immobilizer 42 of the vehicle 4 from the vehicle information server 3, the ECU 41 controls the immobilizer 42 to lock the engine start of the vehicle 4. Furthermore, when acquiring a signal for releasing the activation of the immobilizer 42 of the vehicle 4 from the vehicle information server 3, the ECU 41 controls the immobilizer 42 to release the engine start lock of the vehicle 4.

The immobilizer 42 enables the engine start lock, or releases the enabling of the engine start lock under the control of the ECU 41.

The positioning unit 43 receives radio waves from, for example, a global positioning system (GPS) satellite, and detects the current position of the vehicle 4. Specifically, the positioning unit 43 calculates a distance between each of GPS satellites and the vehicle 4 based on time when each of the plurality of GPS satellites has transmitted radio waves and time when the positioning unit 43 has received the radio waves. The positioning unit 43 calculates the current position of the vehicle 4 based on the distances. Note that a method of detecting the current position of the vehicle 4 with the positioning unit 43 is not limited to a method using a GPS satellite. For example, the current position of the vehicle 4 may be detected by combining light detection and ranging/laser imaging detection and ranging (LiDAR) with a 3D map.

The communicator 44 includes, for example, a data communication module (DCM). The communicator 44 exchanges information with the vehicle information server 3 by communication via the network N.

Examples of the in-vehicle equipment 45 include a navigation device (car navigation system), air conditioning equipment (air conditioner), a navigation device (car navigation system), a car audio system, a monitor, a dashboard camera, and an ETC. In the embodiment, an example of a case where a car navigation system is mainly used as the in-vehicle equipment 45 will be described.

### Lock Release Application Device

The lock release application device 5 applies for release of engine start lock to the debt collection server 1. Examples of the lock release application device 5 include an information processing terminal (e.g., personal computer and smartphone) held by a user or a holder of the vehicle 4.

Examples of the release application information transmitted from the lock release application device 5 to the debt collection server 1 include the following information.

(1) Time zone when the user uses the vehicle 4 (lock release time zone): for example, "9:00 AM to 10:00"

(2) Period when the user uses the vehicle 4 (lock release period): for example, "one hour"

(3) Goal (destination) of the vehicle 4: for example, "workplace"

### First Processing in Debt Collection Server

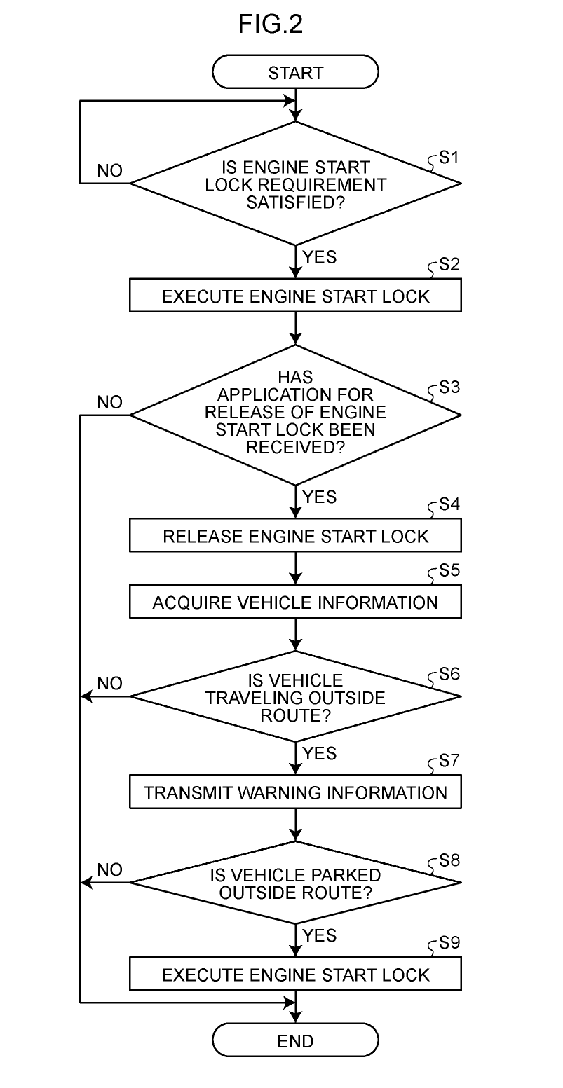

An example of the flow of first processing in the debt collection server 1 will be described with reference to FIG. 2. An example of a case where the user is warned if the vehicle 4 travels off a route for which an application has been made during the release of the engine start lock will be described below.

First, the controller 11 determines whether or not the vehicle 4 satisfies the requirement of the engine start lock (Step S1). In Step S1, when acquiring, for example, information for identifying the vehicle 4 that satisfies the engine start lock requirement from the debt management server 2, the controller 11 determines that the requirement of the engine start lock is satisfied.

When determining, in Step S1, that the vehicle 4 satisfies the requirement of the engine start lock (Yes in Step S1), the controller 11 remotely operates the vehicle 4 to execute the engine start lock (Step S2). In Step S2, the controller 11 executes the engine start lock by transmitting, for example, a signal for activating the immobilizer 42 to the vehicle 4 via the vehicle information server 3.

Subsequently, the controller 11 determines whether or not an application for release of the engine start lock has been received (Step S3). In Step S3, when acquiring release application information of the engine start lock from the lock release application device 5, the controller 11 determines that the application for release of the engine start lock has been received.

When determining, in Step S3, that the application for release of the engine start lock has been received (Yes in Step S3), the controller 11 remotely operates the vehicle 4 to release the engine start lock (Step S4). In Step S4, the controller 11 releases the engine start lock by transmitting, for example, a signal for releasing the activation of the immobilizer 42 to the vehicle 4 via the vehicle information server 3.

Subsequently, the controller 11 acquires vehicle information including vehicle position information and vehicle speed information from the vehicle information server 3 (Step S5). Subsequently, the controller 11 determines whether or not the vehicle 4 is traveling outside the route for which an application has been made based on the vehicle information acquired in Step S5 (Step S6). When determining, in Step S6, that the vehicle 4 is traveling outside the route (Yes in Step S6), the controller 11 generates warning information, and transmits the warning information to the vehicle 4 via the vehicle information server 3 (Step S7). The in-vehicle equipment 45 of the vehicle 4 thereby outputs the warning information.

Subsequently, the controller 11 determines whether or not the vehicle 4 has been parked outside the route for which an application has been made based on the vehicle information acquired in Step S5 (Step S8). When determining, in Step S8, that the vehicle 4 has been parked outside the route (Yes in Step S8), the controller 11 remotely operates the vehicle 4 to execute the engine start lock (Step S9), and completes the processing. In Step S9, the controller 11 executes the engine start lock by transmitting, for example, a signal for activating the immobilizer 42 to the vehicle 4 via the vehicle information server 3.

Here, when determining, in Step S1, that the vehicle 4 does not satisfy the requirement of the engine start lock (No in Step S1), the controller 11 returns to the determination in Step S1. Furthermore, when determining, in Step S3, that the application for release of the engine start lock has not been received (No in Step S3), the controller 11 completes the processing. Furthermore, when determining, in Step S6, that the vehicle 4 is not traveling outside the route for which an application has been made (No in Step S6), the controller 11 completes the processing. Furthermore, when determining, in Step S8, that the vehicle 4 is not parked outside the route for which an application has been made (No in Step S8), the controller 11 completes the processing.

### Second Processing in Debt Collection Server

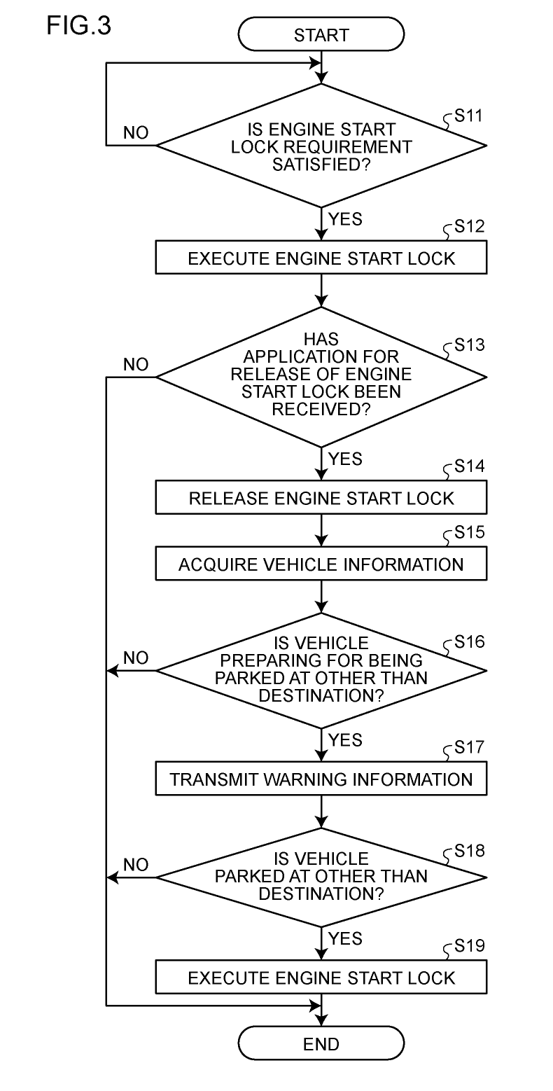

An example of the flow of second processing in the debt collection server 1 will be described with reference to FIG. 3. An example of a case where the user of the vehicle 4 is warned if the vehicle 4 is about to be parked at a place other than the destination (goal) for which an application has been made during the release of the engine start lock will be described below.

First, the controller 11 determines whether or not the vehicle 4 satisfies the requirement of the engine start lock (Step S11). In Step S11, when acquiring, for example, information for identifying the vehicle 4 that satisfies the engine start lock requirement from the debt management server 2, the controller 11 determines that the requirement of the engine start lock is satisfied.

When determining, in Step S11, that the vehicle 4 satisfies the requirement of the engine start lock (Yes in Step S11), the controller 11 remotely operates the vehicle 4 to execute the engine start lock (Step S12). In Step S12, the controller 11 executes the engine start lock by transmitting, for example, a signal for activating the immobilizer 42 to the vehicle 4 via the vehicle information server 3.

Subsequently, the controller 11 determines whether or not an application for release of the engine start lock has been received (Step S13). In Step S13, when acquiring release application information of the engine start lock from the lock release application device 5, the controller 11 determines that the application for release of the engine start lock has been received.

When determining, in Step S13, that the application for release of the engine start lock has been received (Yes in Step S13), the controller 11 remotely operates the vehicle 4 to release the engine start lock (Step S14). In Step S14, the controller 11 releases the engine start lock by transmitting, for example, a signal for releasing the activation of the immobilizer 42 to the vehicle 4 via the vehicle information server 3.

Subsequently, the controller 11 acquires vehicle information including vehicle position information and vehicle speed information from the vehicle information server 3 (Step S15). Subsequently, the controller 11 determines whether or not the vehicle 4 is preparing for being parked at other than the destination for which an application has been made based on the vehicle information acquired in Step S15 (Step S16). In Step S16, when the vehicle 4 decelerates to a speed lower than that of a crawl, the controller 11 determines that the vehicle 4 is preparing for being parked. When determining, in Step S16, that the vehicle 4 is preparing for being parked at other than the destination (Yes in Step S16), the controller 11 generates warning information, and transmits the warning information to the vehicle 4 via the vehicle information server 3 (Step S17). The in-vehicle equipment 45 of the vehicle 4 thereby outputs the warning information.

Subsequently, the controller 11 determines whether or not the vehicle 4 has been parked at other than the destination for which an application has been made based on the vehicle information acquired in Step S15 (Step S18). When determining, in Step S18, that the vehicle 4 has been parked at other than the destination (Yes in Step S18), the controller 11 remotely operates the vehicle 4 to execute the engine start lock (Step S19), and completes the processing. In Step S19, the controller 11 executes the engine start lock by transmitting, for example, a signal for activating the immobilizer 42 to the vehicle 4 via the vehicle information server 3.

Here, when determining, in Step S11, that the vehicle 4 does not satisfy the requirement of the engine start lock (No in Step S11), the controller 11 returns to the determination in Step S11. Furthermore, when determining, in Step S13, that the application for release of the engine start lock has not been received (No in Step S13), the controller 11 completes the processing. Furthermore, when determining, in Step S16, that the vehicle 4 is not preparing for being parked at other than the destination for which an application has been made (No in Step S16), the controller 11 completes the processing. Furthermore, when determining, in Step S18, that the vehicle 4 has not been parked at other than the destination for which an application has been made (No in Step S18), the controller 11 completes the processing.

### Third Processing in Debt Collection Server

An example of the flow of third processing in the debt collection server 1 will be described. An example of a case where the shortest course between a destination and a home included in the release application information of the engine start lock is received as an application route of the user will be described below.

First, when determining that the vehicle 4 satisfies the requirement of the engine start lock, the controller 11 remotely operates the vehicle 4 to execute the engine start lock. Subsequently, when receiving an application for release of the engine start lock by acquiring a release application information of the engine start lock from the lock release application device 5, the controller 11 remotely operates the vehicle 4 to release the engine start lock.

In the case, the controller 11 searches for the shortest course between the goal (destination) of the vehicle 4 and the home of the user included in the release application information. Then, the controller 11 receives the shortest course which has been searched for as an application route for release of the engine start lock from the user.

Subsequently, when determining that the vehicle 4 is traveling outside the above-described application route (shortest route from home to destination), the controller 11 generates warning information, and transmits the warning information to the vehicle 4 via the vehicle information server 3. The in-vehicle equipment 45 of the vehicle 4 thereby outputs the warning information. Furthermore, when determining that the vehicle 4 has been parked outside the above-described application route, the controller 11 remotely operates the vehicle 4 to execute the engine start lock.

### Fourth Processing in Debt Collection Server

An example of the flow of fourth processing in the debt collection server 1 will be described. An example of a case where a route itself including a destination set in the vehicle 4 is defined as release application information of the engine start lock will be described below.

First, when determining that the vehicle 4 satisfies the requirement of the engine start lock, the controller 11 remotely operates the vehicle 4 to execute the engine start lock. Subsequently, when receiving an application for release of the engine start lock by acquiring a release application information of the engine start lock from the lock release application device 5, the controller 11 remotely operates the vehicle 4 to release the engine start lock.

In the case, the controller 11 acquires information on the destination of the vehicle 4 and a route from the current position to the destination from the car navigation system of the vehicle 4. Then, the controller 11 receives the route acquired from the car navigation system as an application route for release of the engine start lock from the user.

Subsequently, when determining that the vehicle 4 is traveling outside the above-described application route (route from current position to destination), the controller 11 generates warning information, and transmits the warning information to the vehicle 4 via the vehicle information server 3. The in-vehicle equipment 45 of the vehicle 4 thereby outputs the warning information. Furthermore, when determining that the vehicle 4 has been parked outside the above-described application route, the controller 11 remotely operates the vehicle 4 to execute the engine start lock.

The vehicle control device according to the above-described embodiment can release the engine start lock based on the contents of an application for release of the engine start lock.

Those skilled in the art can easily derive additional effects and variations. Thus, the broader aspect of the present disclosure is not limited to the specific details and the representative embodiment represented and written above. Therefore, various modifications can be made without departing from the spirit or scope of the general inventive concept defined by the appended claims and equivalents thereof.

For example, although, in the embodiment, description has been given on the assumption that the debt collection server 1 functions as the vehicle control device, the vehicle 4 itself may function as the vehicle control device. In this case, the vehicle 4 may have functions of the controller 11 of the debt collection server 1 and the vehicle history DB 12. Furthermore, in the vehicle control device according to the embodiment, the vehicle 4 may perform parts of pieces of processing of the debt collection server 1 and the vehicle information server 3.

For example, the debt collection server 1 may perform all of (1) and (2) below, or the vehicle 4 may perform all of (1) and (2) below. Furthermore, the vehicle 4 may perform (1) below, and the debt collection server 1 may perform (2) below. Furthermore, the vehicle 4 may perform (2) below, and the debt collection server 1 may perform (1) below.

(1) Engine start lock

(2) Release of engine start lock

Furthermore, although, in the embodiment, the debt collection server 1, the debt management server 2, and the vehicle information server 3 have been described as separate devices, the debt collection server 1, the debt management server 2, and the vehicle information server 3 may be configured by one or two or four or more devices.

According to the present disclosure, engine start lock can be released based on the contents of an application for release of the engine start lock.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle control device comprising a processor configured to:
remotely control a vehicle to lock engine start of the vehicle by outputting, to the vehicle, a signal for activating an immobilizer of the vehicle when the vehicle satisfies a predetermined requirement of engine start lock, and
remotely control the vehicle to release lock of the engine start by outputting, to the vehicle, a signal for releasing activation of the immobilizer of the vehicle when acquiring release application information of the engine start lock, and wherein
the release application information includes at least one of information on a use period of the vehicle and information on a destination of the vehicle.

2. A vehicle control device comprising a processor configured to:
remotely control a vehicle to lock engine start of the vehicle when the vehicle satisfies a predetermined requirement of engine start lock, and
remotely control the vehicle to release lock of the engine start when acquiring release application information of the engine start lock, and wherein
the release application information includes at least one of information on a use period of the vehicle and information on a destination of the vehicle.

3. The vehicle control device according to claim 2
wherein the processor is further configured to:
acquire information on a position and a speed of the vehicle,
remotely control the vehicle to cause in-vehicle equipment of the vehicle to output warning information when the vehicle travels off a route to the destination included in the release application information during release of the engine start lock, and
remotely control the vehicle to lock the engine start of the vehicle when the vehicle is parked at a place off the route to the destination included in the release application information during the release of the engine start lock.

4. The vehicle control device according to claim 2
wherein the processor is further configured to:
acquire information on a position and a speed of the vehicle,
remotely control the vehicle to cause in-vehicle equipment of the vehicle to output warning information when the vehicle decelerates to a predetermined speed at a place other than the destination included in the release application information during release of the engine start lock, and
remotely control the vehicle to lock the engine start of the vehicle when the vehicle is parked at a place other than the destination included in the release application information during the release of the engine start lock.
